(19) United States
(12) Patent Application Publication
(10) Pub. No.: US 2007/0227463 A1
(43) Pub. Date: Oct. 4, 2007

(54) Puppy comforter

(76) Inventor: Carmen Polito, East Amherst, NY (US)

Correspondence Address: SIMPSON & SIMPSON, PLLC, 5555 MAIN STREET, WILLIAMSVILLE, NY, 14221-5406, US

(21) Appl. No.: 11/396,039

(22) Filed: Apr. 3, 2006

(51) Int. Cl. A01K 29/00

(52) U.S. Cl. 119/707

(57) ABSTRACT

An puppy comforter is disclosed having a shape in the form of an animal, the housing having a cavity with an opening accessible from the exterior, the cavity containing a microwave heatable pouch formed from a durable plastic and containing dissociated grains of Bulger wheat, together with a mechanical clock which generates a ticking sound, the combination providing comfort to an animal.

This invention relates generally to the field of stuffed doll comforters, and more particularly to an improved stuffed doll device adapted to train and comfort young animals.

### BACKGROUND OF THE INVENTION

It is generally well known that when young puppies are taken from their mother they have difficulty adjusting to new surroundings, a problem that is particularly annoying at night when difficulty in sleeping causes them to whine, bark and even to gnaw and incessantly lick various items, behavior which is generally undesired by their human owners. Such behavior is generally attributed to a lack of emotional security which stems from the lack of feeling the warmth and sounds of their birth mother's body. Since it is ordinarily not possible to provide a feeling of security in such circumstance, it is among the principal objects of the present invention to provide a device capable of simulating birth mother sensations with a view toward imparting a feeling of security yet maintaining training of the young puppy.

Another object of the invention lies in the provision of an improved puppy comforting device in the form of a recognizable figure, having means for imparting warmth to a puppy placed beside it and having means for simulating the comforting sounds of an adult animal.

A further object of the invention lies in the provision of a device which is substantially trouble-free in operation through its useful life by being resistant to normal activities of a puppy such as gnawing and licking.

These and other objects, as well as other incidental advantages, will become more clear from the following disclosure.

### BRIEF SUMMARY OF THE INVENTION

The comforter of the invention generally comprises a stuffed animal in the general shape of a dog, having an exterior surface comprising a repellant which discourages chewing, gnawing and licking by a dog, and an interior comprising means which generally mimic a birth mother's warmth and sounds.

Such combination of disparate encouragement and discouragement components has been found to provide a unique training tool for young puppies, which reinforces desirable behavior sought by their human owners within the comforting environment of their birth mother. Thus, instead of the puppy associating the instincts of licking and gnawing with the comfort of a mother's closeness, the puppy associates the attraction of a mother's warmth and sounds such as her heartbeat and the like with a repulsion to licking and gnawing.

The unique stuffed animal of the invention has a soft, chew and lick repelling exterior and a sound producing means enclosed within the interior together with a heat source.

The exterior surface of the stuffed animal comprises a soft, pliable covering, preferably formed from a material which has touch and feel characteristics attractive to a common puppy, yet strong and durable enough to retain its desired physical shape even when subjected to ripping and tearing actions by a normal playful puppy. In a preferred embodiment, the material covering the doll is selected to provide touch and feel characteristics of an adult female dog and the pliable covering is treated with a chew and/or lick repellant to counteract the chewing and licking instincts of most puppies. The combining of the touch and feel characteristics together with chew and/or lick repellant, provides the puppy with a reminder of the security projected by its mother and her reaction to undesirable activity. Thus the training of the dog comes from seeking comfort from its mother as distinct from fear of its owner.

Chew and/or lick repellant compositions are commonly marketed and commercially available through pet supply stores, typically to repel dogs from chewing furniture and various small items which the dog may be attracted to. Most chew repellant materials are available as liquid sprays which do not harm the animal or the material they are sprayed on, and generally have little or no smell. It is believed that such compositions rely upon a non-desirable taste for their deterring effect.

The interior of the doll can be stuffed with a variety of materials well known in the manufacture of dolls, such as cotton, feathers, wool, silk, elastomeric foams and the like. Any suitable material may be used for stuffing the interior of the animal, but for purposes of the present invention a significant portion of the stuffing material must comprise material which can function as a heat source. In a preferred embodiment, the heat source comprises a pliable material which can be excited in a microwave oven to a heated state, and will slowly dissipate through the stuffing and covering of the stuffed doll. Thus in one embodiment, the stuffed animal comprises a removable microwaveable pouch containing a pliable heat absorbing material which has good heat retention qualities and can be easily excited to a heated condition in a microwave oven. In a preferred embodiment, a particulate material is provided within a flexible pouch, which can be easily excited to a heated condition while retaining its dissociated form, so that the pouch can be easily manipulated to conform to various shaped spaces for insertion into the doll. In a particularly preferred embodiment particulate materials such as dried wheat, particularly Bulgur wheat, or rice, corn, peas or the like comprise the microwaveable excitable material, these materials being non-toxic in the event of a breach of the doll and/or microwaveable pouch by the puppy. A further advantage of such latter materials is that they provide a pleasant odor upon heating and are typically inexpensively available at local food stores if replacement material is required.

The device which mimics a birth mother's sounds can produce any suitable sound or series of sounds which create a reminder of the birth mother sounds for the puppy. In a preferred embodiment, the sound producing device is contained within a protective housing resistant to gnawing and liquid permeation. The sound generated can be any suitable sound which reminds the puppy of the presence of a birth mother, including breathing sounds, fluid movement sounds, heart beat sounds, purring sounds and the like. Methods and devices for electronically producing sounds of such nature are well known in the art and are widely available in battery powered miniaturized form. Such devices can be activated and deactivated by remote control, manual switches, automatically by a specified movement of the doll, timers and the like. One generally preferred sound is a uniform pulse mimicking the heartbeat of a mother, particularly a fluid pulse sound.

The mimicking device can be permanently arranged within the interior of the stuffed doll, but preferably is removably arranged to enable convenient laundering of the doll. In one embodiment, the device is contained within a removable pouch comprising heat insulating material, to protect against overheating the device when arranged proximate the heated materials inserted into the doll. The device pouch can be removed from the interior of the doll for repair, changing a battery, changing the sound or when heating the stuffed doll by microwave oven or the like, and re-installed for use. In a preferred embodiment however, the doll itself generally is not preferred to be heated in the microwave oven, but only the pouch containing the pliable heat absorbing materials.

### BRIEF DESCRIPTION OF THE DRAWINGS

In the drawing, to which reference will be made in the specification, similar reference characters have been employed to designate corresponding parts throughout the several views.

FIG. 1 is a sectioned perspective view illustrating an embodiment of the invention.

FIG. 2 is a sectional view of a removable pouch comprising a heat emitting means of the invention.

### DETAILED DESCRIPTION OF THE DRAWINGS

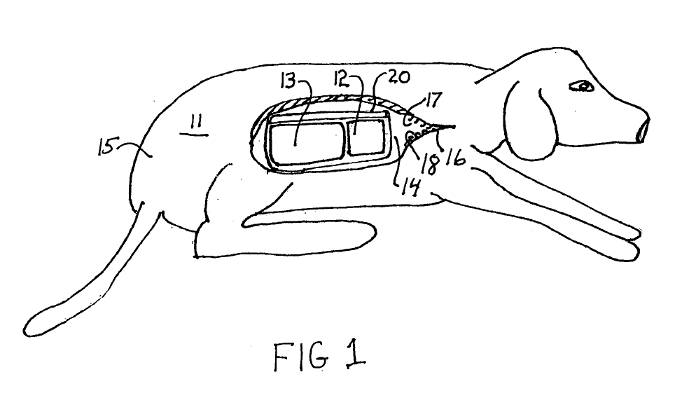

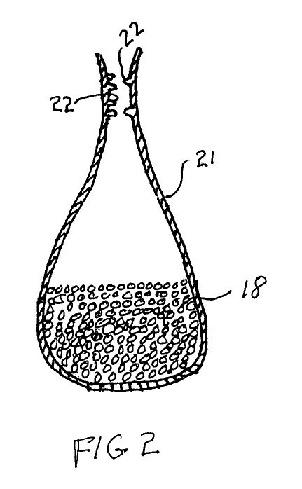

Turning now to the drawings, in which the same reference numerals are used to indicate corresponding elements throughout the several views, attention is directed to FIGS. 1 through 4 which illustrate a pet comforter doll constructed in accordance with the teaching of the present invention.

Throughout the specification, the terms “front” and “rear” and “interior” and “exterior” are used to establish a frame of reference for description and discussion of the doll. These terms are not to be construed in any limiting sense.

The components of the invention are removably arranged within a first pouch 20, contained in cavity 14 of housing 11, and comprises a birth mother's sound mimicking means 12 and a heat emitting means 13.

In the illustrated embodiment housing 11 is formed to simulate a dog or other animal, preferably in a reclining or sleeping position, and is generally preferred to comprise a soft exterior covering 15, and most preferably to be manufactured in the form of a stuffed toy or the like. The exterior covering is illustrated as formed from common durable materials used in toy manufacturing, simulating a fur like surface and is illustrated as preferably comprising representative body parts, such as an elongated torso, legs, tail and head of a dog.

Access opening 16 is provided to cavity 14 within the interior of housing 11, the opening being illustrated as comprising preferred hook 17 and loop 18 strips, which are pressed together to secure the opening from entry. Cavity 14 is dimensioned to accept first pouch 20, containing mimicking means 12 and heat emitting means 13, preferably in tight communication so as to minimize movement between components during any playful activities or the like by the animal being trained.

By sound mimicking, means is meant any suitable means which produces a repetitious sound and/or movement which can be detected by an animal resting against the housing. Thus, in one embodiment the sound mimicking means comprises a diaphragm which expands and contracts in a defined sequence which produces a sound, and which is arranged within the cavity to transmit movement through the covering of the housing so as to be detectable to the animal to be trained when it is leaning against the housing. In a preferred embodiment, such sound mimicking means generates a movement during its activity which can also be detected by the animal to be trained. In the illustrated embodiment, sound mimicking means 12 is illustrated as comprising a wind-up mechanical clock mechanism which typically emits a ticking sound, generated a the faint catch and release movement, which can be detected by an animal as it is transmitted through the covering of the housing of the typical mechanical release.

Heat emitting means 13, is illustrated as comprising a second removable pouch 21, containing a heat retaining substance. Pouch 21 is formed from a durable plastic material which is resistant to penetration by gnawing and can be subject to microwave excitement to generate heat therein without appreciable destruction thereof. The pouch is illustrated as comprising Bulger wheat grains 18. It has been found that this particular combination of Bulger wheat grains confined within a durable plastic pouch is a particularly suitable heat emitting means in that it can be conveniently heated and re-heated to a high temperature in a typical microwave oven without significant decay of either the wheat grains or the plastic material confining same. Pouch 21 is illustrated as comprising a sealable opening wherein the sealing means comprising generally parallel ridges 22, on opposing sides of an opening to the pouch which are offset arranged to forcible mate within opposing slots formed thereby and seal the contents of the pouch, an arrangement commonly used in flexible plastic pouches typically provided for storage of food and the like. The resealable pouch and wheat grain arrangement of the invention provides a safe product in the event the pouch is penetrated by the dog, the wheat grains being edible.

I claim:

1. A device for comforting animals comprising:
a housing in the form of an animal figure, said figure having a cavity with a re-sealable opening to the exterior thereof;
a heat emitting device arranged within said cavity, said heat emitting device comprising a pouch containing a particulate material excitable by microwave to a heated temperature; and
a birth mother sound mimicking device arranged within said cavity, said birth mother sound mimicking device enabled to provide a repeating sound.

2. The device of claim 1 wherein said birth mother sound mimicking device generates sound by mechanical movement.

3. The device of claim 2 wherein the mechanical movement is detectable by an animal.

4. The device of claim 1 wherein said pouch comprises a closable opening.

5. The device of claim 4 wherein said pouch is formed from a durable plastic.

6. The device of claim 5 wherein generally parallel ridges on opposing sides of said closable opening, offset engage to form a closed seal.

7. The device of claim 4 wherein said particulate material comprises grains of wheat.

8. The device of claim 7 wherein said grains of wheat comprise Bulger wheat.

9. The device of claim 1 wherein said particulate material comprises grains of wheat.

10. The device of claim 9 particulate material grains of wheat comprise Bulger wheat.

11. The device of claim 9 wherein said pouch is formed from a durable plastic.

12. The device of claim 3 wherein said birth mother sound mimicking device comprises a wind up mechanical clock.

13. A device for comforting animals comprising a housing in the form of an animal, said figure having a cavity with a closable opening to the exterior thereof, the cavity containing a pouch formed from a durable plastic containing dissociated grains of Bulger wheat and a mechanical clock which generates a ticking sound audible exterior said figure.

14. A device of claim 1 wherein said pouch comprises a closable opening wherein generally parallel ridges on opposing sides of said closable opening, offset engage to form a closed seal.
